(19) United States
(12) Patent Application Publication
(10) Pub. No.: US 2022/0134894 A1
(43) Pub. Date: May 5, 2022

(54) CONTROL DEVICE, NON-CONTACT POWER SUPPLY PROGRAM, AND NON-CONTACT POWER SUPPLY SYSTEM

(71) Applicant: TOYOTA JIDOSHA KABUSHIKI KAISHA, Toyota-shi (JP)

(72) Inventors: Ayano KIMURA, Susono-shi (JP); Hikaru SHIOZAWA, Susono-shi (JP); Toshiya HASHIMOTO, Miyoshi-shi (JP); Chuya OGAWA, Susono-shi (JP); Yuta MANIWA, Susono-shi (JP)

(73) Assignee: TOYOTA JIDOSHA KABUSHIKI KAISHA, Toyota-shi (JP)

(21) Appl. No.: 17/469,123

(22) Filed: Sep. 8, 2021

(30) Foreign Application Priority Data
Nov. 2, 2020 (JP) 2020-183942

(51) Int. Cl. B60L 53/12; B60L 53/66; H02J 50/80

(52) U.S. Cl. CPC B60L 53/12; H02J 50/80; B60L 53/66

(57) ABSTRACT

A control device according to the present disclosure includes a processor configured to make power supply capacity of a non-contact power supply device smaller when disaster information is acquired than when the disaster information is not acquired.

### CROSS-REFERENCE TO RELATED APPLICATION

This application claims priority to Japanese Patent Application No. 2020-183942 filed on Nov. 2, 2020, incorporated herein by reference in its entirety.

### BACKGROUND

### 1. Technical Field

The present disclosure relates to a control device, a non-contact power supply program, and a non-contact power supply system.

### 2. Description of Related Art

WO 2011/142421 discloses a vehicle resonance type non-contact power supply system including non-contact power supply devices provided along a plurality of power supply lanes branched off from a vehicle travel road.

### SUMMARY

A non-contact power supply device that supplies power to a vehicle in a non-contact manner is required to be able to supply power also to electric devices other than the vehicle in a non-contact manner when a disaster occurs.

The present disclosure has been made in view of the above, and it is an object of the present disclosure to provide a control device, a contact power supply program, and a non-contact power supply system that are all capable of performing non-contact power supply by reducing the power supply capacity of a non-contact power supply device when a disaster occurs.

A control device according to the present disclosure includes a processor configured to make power supply capacity of a non-contact power supply device smaller when disaster information is acquired than when the disaster information is not acquired.

A non-contact power supply program according to the present disclosure causes a processor to make power supply capacity of a non-contact power supply device smaller when disaster information is acquired than when the disaster information is not acquired.

A non-contact power supply system according to the present disclosure includes: a control device including a first processor configured to make power supply capacity of a non-contact power supply device smaller when disaster information is acquired than when the disaster information is not acquired; and a server including a second processor configured to output the disaster information to the control device.

According to the present disclosure, non-contact power supply can be performed by reducing the power supply capacity of a non-contact power supply device when a disaster occurs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a non-contact power supply system according to an embodiment;

FIG. 2 is a schematic configuration diagram of a non-contact power receiving device and a non-contact power supply device;

FIG. 3 is a schematic configuration diagram of an in-vehicle terminal;

FIG. 4 is a diagram showing a power supply mode control routine;

FIG. 5 is a diagram showing an example of the non-contact power supply system when an electric device is a cooking device; and

FIG. 6 is a diagram showing an example of the non-contact power supply system when the electric device is a mobile communication terminal device.

### DETAILED DESCRIPTION OF EMBODIMENTS

Hereinafter, an embodiment of a non-contact power supply system according to the present disclosure will be described. The present embodiment does not limit the present disclosure.

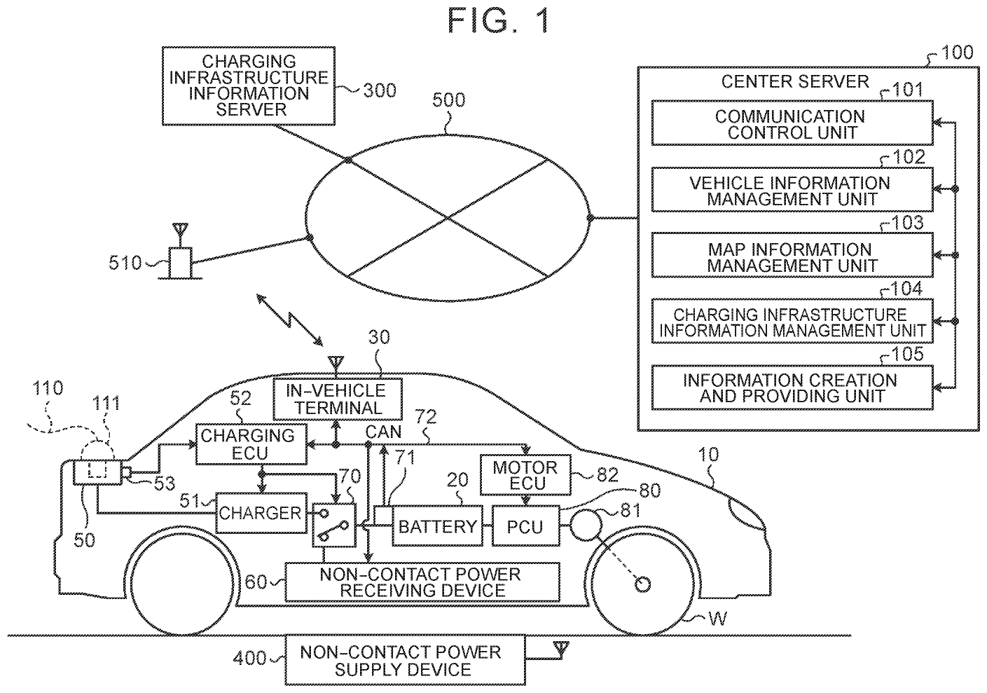

FIG. 1 is a diagram showing a non-contact power supply system according to an embodiment. A vehicle 10 to which the non-contact power supply system is applied is an electric vehicle that travels by driving a traction motor using electric power from a battery.

The non-contact power supply system includes an in-vehicle terminal 30, a center server 100, a charging infrastructure information server 300, a non-contact power supply device 400, and a communication network 500. The in-vehicle terminal 30 is an in-vehicle information communication terminal device associated with the vehicle 10. The center server 100 functions as a navigation server provided in a vehicle information center. The charging infrastructure information server 300 is provided in a charging infrastructure center. The non-contact power supply device 400 is provided in a road that is a travel road of the vehicle 10. The communication network 500 is the Internet or the like through which the in-vehicle terminal 30, the center server 100, the charging infrastructure information server 300, and the non-contact power supply device 400 are connected so as to be able to communicate with each other. A wireless base station 510 is connected to the communication network 500, and the in-vehicle terminal 30 is connected to the communication network 500 via the wireless base station 510.

The vehicle 10 includes a battery 20 that serves as an energy source for traveling. The vehicle 10 has two power supply systems including a cable-connected power supply system in which power is supplied from an external power supply to the battery 20 via a charging cable 110, and a non-contact power supply system in which electric power transmitted from the non-contact power supply device 400 is received in a non-contact manner and supplied to the battery 20.

The cable-connected power supply system includes a power receiving port 50, a charger 51, and a charging electronic control unit (ECU) 52. The power receiving port 50 is a connection port for a connection plug 111 of the charging cable 110. The charger 51 converts electric power supplied to the power receiving port 50 into electric power for charging the battery 20, and charges the battery 20. The charging ECU 52 is a charging control device that controls charging of the battery 20 by the charger 51. The non-contact power supply system includes a non-contact power receiving device 60. The charger 51 and the non-contact power receiving device 60 are each connected to an input terminal of a selection switch 70. One of the output of the charger 51, which is the output of the cable-connected power supply system, and the output of the non-contact power receiving device 60 is selectively supplied to a charging path to the battery 20 by the selection switch 70.

The battery 20 is provided with a state of charge (SOC) detector 71 that detects an SOC, which is a value indicating the state of charge of the battery 20. The SOC detector 71 outputs, as the SOC, a signal representing a value serving as an index of the amount of electric energy that can be output from the battery 20. The SOC detector 71 outputs the signal to a controller area network (CAN) communication line 72 of a CAN communication system at a predetermined cycle. Hereinafter, the SOC detected by the SOC detector 71 is also referred to as a remaining battery level. The remaining battery level may be represented by, for example, a charge rate [%] or the amount of electric energy that can be output from the battery 20.

The charging ECU 52 is configured by using a microcomputer including: a processor including a central processing unit (CPU) or a field-programmable gate array (FPGA), and a memory including a random access memory (RAM) or a read only memory (ROM). To charge the battery 20, the charging ECU 52 acquires the remaining battery level detected by the SOC detector 71 through the CAN communication line 72. The charging ECU 52 activates the charger 51 to charge the battery 20 until the remaining battery level reaches a target value set by a user (for example, fully charged battery level). Moreover, the charging ECU 52 changes the selection status of the selection switch 70 so that the cable-connected power supply system is electrically connected to the battery 20 when the connection plug 111 of the charging cable 110 is attached to the power receiving port 50. Moreover, the charging ECU 52 changes the selection status of the selection switch 70 so that the non-contact power supply system is electrically connected to the battery 20 when the connection plug 111 of the charging cable 110 is not attached to the power receiving port 50. The power receiving port 50 is provided with a detection switch 53 that detects whether the connection plug 111 is connected to the power receiving port 50. The charging ECU 52 receives a detection signal from the detection switch 53 to determine whether the connection plug 111 is connected, and controls switching by the selection switch 70.

The vehicle 10 includes, as a traveling drive system configuration, a power control unit (PCU) 80, a motor 81 for traveling, and a motor ECU 82. The PCU 80 converts direct current (DC) power output from the battery 20 into three-phase alternating current (AC) power. The motor 81 is driven by the three-phase AC power output from the PCU 80 to rotate wheels W. The motor ECU 82 is a motor control unit that controls the output of the PCU 80 in accordance with the driving operation of a driver. The motor ECU 82 is configured by using a microcomputer including a processor including a CPU or an FPGA and a memory including a RAM or a ROM.

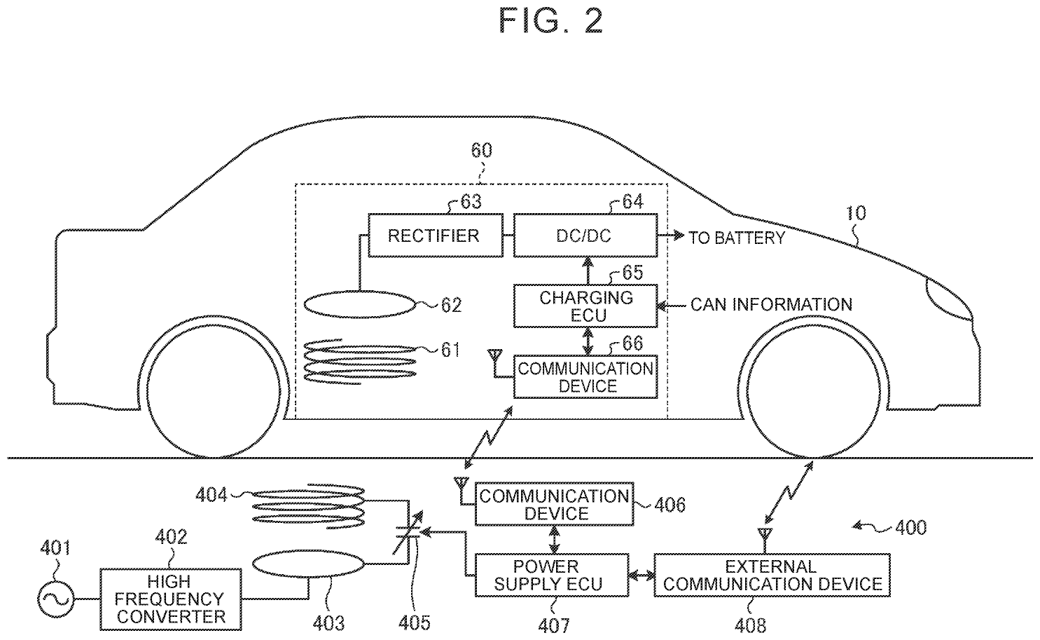

FIG. 2 is a schematic configuration diagram of the non-contact power receiving device 60 and the non-contact power supply device 400. Regarding FIG. 2, although a case will be described in which a magnetic field resonance method (electric field coupling) is used as a method of supplying power from the non-contact power supply device 400 to the non-contact power receiving device 60 in a non-contact manner, the power supply method may be an electromagnetic induction (magnetic field coupling) method.

The non-contact power receiving device 60 provided in the non-contact power supply system is supplied with power in a non-contact manner from the non-contact power supply device 400 provided in a road. The non-contact power supply device 400 includes an AC power supply 401, a high frequency converter 402, an electromagnetic induction coil 403, a primary coil 404, a variable capacitor 405, a communication device 406, a power supply ECU 407 serving as a power supply control device, and an external communication device 408. The power supply ECU 407 is configured by using a microcomputer including a processor including a CPU or an FPGA and a memory including a RAM or a ROM.

The AC power supply 401 is, for example, a system power supply that is supplied by an electric company. The high frequency converter 402 converts electric power supplied from the AC power supply 401 into electric power having a predetermined frequency, and outputs the converted electric power to the electromagnetic induction coil 403. The electromagnetic induction coil 403 is disposed coaxially with the primary coil 404, and can be magnetically coupled to the primary coil 404 through electromagnetic induction. The electromagnetic induction coil 403 outputs, through electromagnetic induction, the high frequency power supplied from the high frequency converter 402 to the primary coil 404.

The primary coil 404 is an LC resonance coil, and configured to be capable of transmitting power to the vehicle 10 by resonating with a secondary coil 61 of the non-contact power receiving device 60 mounted in the vehicle 10 via an electromagnetic field. The variable capacitor 405 is provided to change the capacitance of a resonance system constituted by the primary coil 404 and the secondary coil 61 of the non-contact power receiving device 60.

The communication device 406 is provided to receive position information of the vehicle 10 to which power is supplied, specifically, position information of the secondary coil 61 of the non-contact power receiving device 60 mounted on the vehicle 10, and a detected value of the speed of the vehicle 10. The communication device 406 receives the position information and the detected value of the speed of the vehicle 10 that are wirelessly transmitted from a communication device 66 provided in the non-contact power receiving device 60.

When power is supplied from the non-contact power supply device 400 to the vehicle 10, the power supply ECU 407 changes the capacitance of the resonance system constituted by the primary coil 404 and the secondary coil 61 of the non-contact power receiving device 60 in accordance with the position information and the detected value of the speed of the vehicle 10 that are received by the communication device 406. When the distance between the primary coil 404 and the secondary coil 61 of the non-contact power receiving device 60 changes, the capacitance between the primary coil 404 and the secondary coil 61 changes, so that the resonance frequency of the resonance system changes. When the resonance frequency deviates significantly from the frequency of transmitted power, that is, the frequency of high frequency electric power generated by the high frequency converter 402, transmission efficiency is significantly reduced. Therefore, the power supply ECU 407 controls the variable capacitor 405 in accordance with the position information and the detected value of the speed of the vehicle 10 such that the resonance frequency of the resonance system is close to the frequency of the high frequency electric power generated by the high frequency converter 402. The power supply ECU 407 thus adjusts the capacitance of the resonance system. For example, the power supply ECU 407 adjusts the capacitance of the variable capacitor 405 to be smaller as the vehicle speed is higher, and to be smaller as the vehicle 10 is farther from the non-contact power supply device 400 (as the distance between the primary coil 404 and the secondary coil 61 is larger).

The external communication device 408 transmits information indicating the operation status of the non-contact power supply device 400 and the like to the charging infrastructure information server 300 at a predetermined cycle via the communication network 500. In this case, the external communication device 408 adds identification data (ID) for identifying the non-contact power supply device 400, and then transmits the operation status information (information indicating whether power can be supplied).

The non-contact power receiving device 60 mounted on the vehicle 10 includes the secondary coil 61, an electromagnetic induction coil 62, a rectifier 63, a DC/DC converter 64, a charging ECU 65 that is a charging control device, and the communication device 66. The charging ECU 65 is configured by using a microcomputer including a processor including a CPU or an FPGA and a memory including a RAM or a ROM.

The secondary coil 61 is an LC resonance coil, and configured to be capable of receiving power from the non-contact power supply device 400 by resonating with the primary coil 404 of the non-contact power supply device 400 via an electromagnetic field. The electromagnetic induction coil 62 is disposed coaxially with the secondary coil 61, and can be magnetically coupled to the secondary coil 61 through electromagnetic induction. The electromagnetic induction coil 62 obtains, through electromagnetic induction, electric power received by the secondary coil 61 and outputs the electric power to the rectifier 63. The rectifier 63 rectifies the AC power output from the electromagnetic induction coil 62 and outputs the rectified electric power to the DC/DC converter 64. The DC/DC converter 64 converts the electric power rectified by the rectifier 63 into a charging voltage level of the battery 20 and outputs the electric power to the battery 20. The charging ECU 65 charges the battery 20 by driving the DC/DC converter 64 when power is received from the non-contact power supply device 400. Moreover, the charging ECU 65 acquires information indicating the vehicle speed and the position of the vehicle from the CAN communication line 72, and outputs the acquired information indicating the vehicle speed and the position of the vehicle to the communication device 66. The communication device 66 wirelessly transmits the information indicating the vehicle speed and the position of the vehicle to the external communication device 408 of the non-contact power supply device 400.

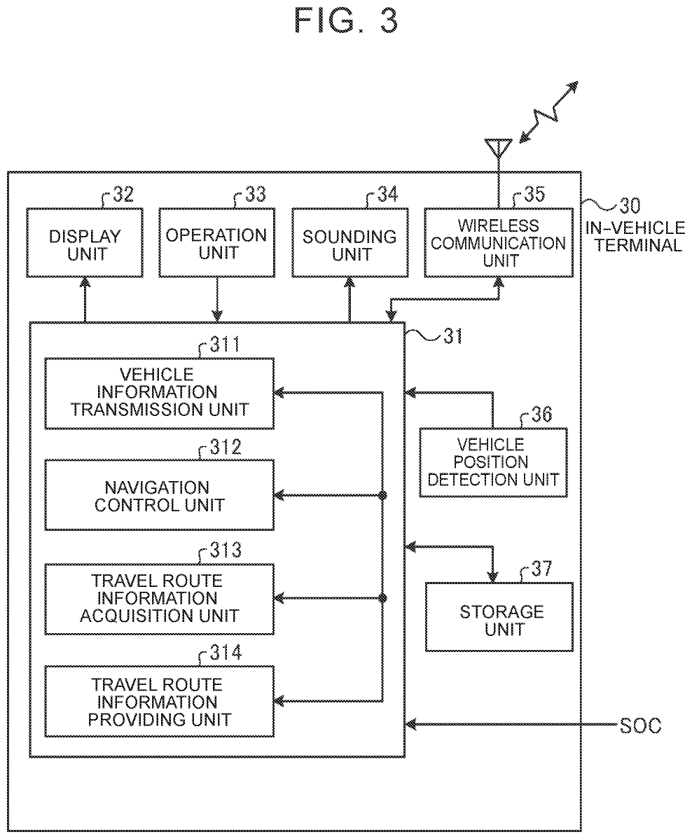

Next, a description will be given of the in-vehicle terminal 30. FIG. 3 is a schematic configuration diagram of the in-vehicle terminal 30. The in-vehicle terminal 30 includes a main control unit 31, a display unit 32, an operation unit 33, a sounding unit 34, a wireless communication unit 35, a vehicle position detection unit 36, and a storage unit 37. The main control unit 31 is configured by using a microcomputer including a processor including a CPU or an FPGA and a memory including a RAM or a ROM. The display unit 32 and the operation unit 33 are configured by using a touch panel display such as a liquid crystal display and an organic electro-luminescence (EL) display. The sounding unit 34 is configured by using an amplifier, a speaker, and the like to provide voice guidance. The wireless communication unit 35 communicates with the outside via the wireless base station 510. The vehicle position detection unit 36 includes a Global Positioning System (GPS) unit that detects the current position coordinates of the vehicle based on radio waves from GPS satellites, and a gyro sensor that detects the traveling direction of the vehicle 10. The storage unit 37 is configured by using a storage device such as an erasable programmable ROM (EPROM) and a hard disk drive (HDD). The storage unit 37 stores map information, facility information, and information such as various vehicle characteristics.

The vehicle 10 has vehicle ECUs that are a plurality of electronic control units that controls the vehicle status. The vehicle ECUs including the charging ECUs 52, 65 and the motor ECU 82, and the SOC detector 71 are connected to the CAN communication line 72, and transmit various vehicle information (for example, mileage information, SOC information, vehicle diagnostics information, and various request information) to the CAN communication line 72. Therefore, each vehicle ECU is configured to be able to share vehicle information via the CAN communication line 72. The in-vehicle terminal 30 is connected to the CAN communication line 72, and transmits to the center server 100 vehicle information transmitted to the CAN communication line 72 in accordance with a predetermined procedure. The center server 100 transmits to the in-vehicle terminal 30 information useful to the user, such as a travel route allowing non-contact charging using the non-contact power supply device 400, based on the vehicle information transmitted from the in-vehicle terminal 30 and the external information acquired from the outside.

The main control unit 31 provided in the in-vehicle terminal 30 includes a vehicle information transmission unit 311, a navigation control unit 312, a travel route information acquisition unit 313, and a travel route information providing unit 314. The vehicle information transmission unit 311 transmits to the center server 100 information of the vehicle (for example, current position information, SOC information, power consumption information, and vehicle diagnostics information) and various request instructions in addition to a vehicle ID (ID for identifying the vehicle 10 or the in-vehicle terminal 30). The navigation control unit 312 guides the vehicle to the destination set by the user based on the map information stored in the storage unit 37 and the vehicle position detected by the vehicle position detection unit 36. The travel route information acquisition unit 313 acquires travel route information (recommended route information) transmitted from the center server 100 and detailed information related to the travel route information (recommended route information). The travel route information providing unit 314 uses the display unit 32 to provide the user with the travel route information (recommended route information) acquired by the travel route information acquisition unit 313 and the detailed information related to the travel route information (recommended route information). The vehicle information transmission unit 311, the navigation control unit 312, the travel route information acquisition unit 313, and the travel route information providing unit 314 are realized by executing a control program (navigation program) of the microcomputer.

The center server 100 includes as a main portion: a microcomputer including a processor including a CPU or an FPGA, and a memory including a RAM or a ROM; and a storage device such as an EPROM and a hard disk drive. As shown in FIG. 1, the center server 100 includes a communication control unit 101, a vehicle information management unit 102, a map information management unit 103, a charging infrastructure information management unit 104, and an information creation and providing unit 105. The communication control unit 101 connects to the communication network 500 to perform communication control. The vehicle information management unit 102 stores and manages vehicle information together with user information. The map information management unit 103 stores and manages road map information. The charging infrastructure information management unit 104 stores and manages information related to the infrastructure of charging facilities. The information creation and providing unit 105 creates and provides information useful to the user.

The charging infrastructure information server 300 includes as a main portion: a microcomputer including a processor including a CPU or an FPGA, and a memory including a RAM or a ROM. The charging infrastructure information server 300 collects the latest operation status of each charging facility (the non-contact power supply device 400 or a facility, such as a power supply station, where batteries are charged), and creates charging infrastructure information indicating the operation status by charging facility. The charging infrastructure information server 300 then transmits the created charging infrastructure information to the center server 100 in real time via the communication network 500. In the center server 100, the charging infrastructure information management unit 104 stores the latest charging infrastructure information transmitted from the charging infrastructure information server 300 and/or updates existing information with the latest charging infrastructure information. The charging infrastructure information management unit 104 of the center server 100 stores positions of facilities on a map in association with map information stored in the map information management unit 103. The charging infrastructure information management unit 104 also stores power supply capacity information for each non-contact power supply device 400. This power supply capacity information defines the amount of electric power that can be supplied to the vehicle 10 when the vehicle 10 passes through a non-contact power supply location at a predetermined vehicle speed.

In the non-contact power supply system according to the embodiment, the power supply capacity of the non-contact power supply device 400 is variable so that the non-contact power supply device 400 can be used for non-contact power supply to not only the vehicle 10 but also an electric device other than the vehicle 10 when a disaster occurs.

The power supply ECU 407 of the non-contact power supply device 400 executes a first power supply mode (first mode) in which first electric energy for performing non-contact power supply to the vehicle 10 is output, when the external communication device 408 does not acquire disaster information. In contrast, when the external communication device 408 acquires disaster information, the power supply ECU 407 of the non-contact power supply device 400 executes a second power supply mode (second mode) in which second electric energy that is smaller than the first electric energy and is used for performing non-contact power supply to an electric device other than the vehicle 10 is output.

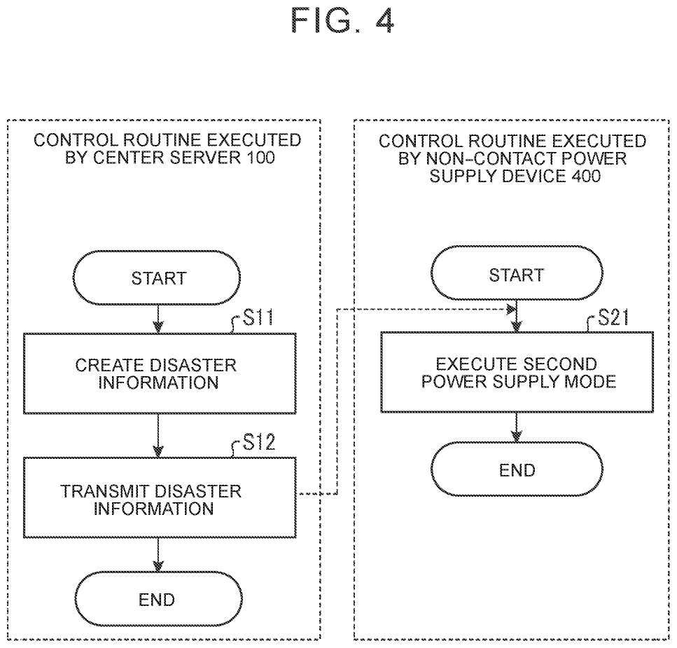

FIG. 4 is a diagram showing a power supply mode control routine. The power supply mode control routine shown in FIG. 4 is executed in collaboration of the center server 100 and the non-contact power supply device 400, and includes a control routine executed by the center server 100 and a control routine executed by the non-contact power supply device 400. The non-contact power supply device 400 starts the power supply mode control routine when disaster information about the occurrence of a disaster is not acquired and thus the first power supply mode in which non-contact power supply to the vehicle 10 is executed.

In step S11, the information creation and providing unit 105 of the center server 100 creates disaster information about the occurrence of a disaster when, for example, a disaster occurs in a predetermined area including the location where the non-contact power supply device 400 is installed. Next, in step S12, the center server 100 transmits the disaster information to the external communication device 408 of the non-contact power supply device 400 via the communication network 500, and this routine is ended. In step S21, the power supply ECU 407 of the non-contact power supply device 400 executes the second power supply mode to reduce the output of the primary coil 404 such that the primary coil 404 has a lower output (smaller power supply capacity) than when non-contact power supply to the vehicle 10 is performed, based on the disaster information acquired by the external communication device 408, and this routine is ended.

With the non-contact power supply system according to the embodiment, it is possible to use the non-contact power supply device 400, which performs non-contact power supply to the vehicle 10 in the first power supply mode in normal times when no disaster occurs, for non-contact power supply to an electric device other than the vehicle 10 when a disaster occurs. In the second power supply mode, non-contact power supply to an electric device is performed with lower output than that in the first power supply mode. Therefore, it is possible to suppress non-contact power supply with excessive output to an electric device.

The power supply ECU 407 of the non-contact power supply device 400 may be capable of selectively executing the first power supply mode in addition to the second power supply mode when disaster information is acquired. This makes it possible to perform non-contact power supply to the vehicle 10 while non-contact power supply from the non-contact power supply device 400 to an electric device is prioritized in disaster situations.

Moreover, when non-contact power supply is performed in the second power supply mode, the power supply ECU 407 of the non-contact power supply device 400 may control the high frequency converter 402 such that high frequency electric power is output to the electromagnetic induction coil 403 while the frequency of the high frequency electric power output to the electromagnetic induction coil 403 is varied in a predetermined range. This makes it possible to perform non-contact power supply by matching the frequency of the high frequency electric power that is output from the electromagnetic induction coil 403 to the primary coil 404 through electromagnetic induction and the resonance frequency of the secondary coil of an electric device even when, for example, the resonance frequency of the secondary coil of the electric device is unknown. Whether the frequency of the high frequency electric power matches the resonance frequency is determined by the power supply ECU 407, for example, through detection of current passing through the primary coil 404.

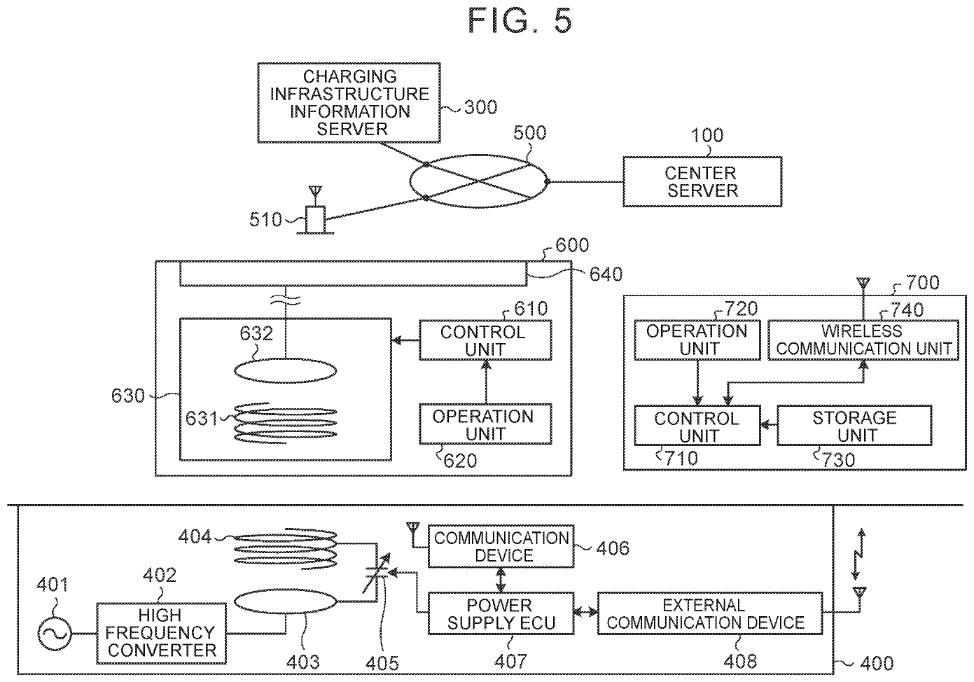

FIG. 5 is a diagram showing an example of the non-contact power supply system when an electric device is a cooking device 600.

In the example shown in FIG. 5, the non-contact power supply device 400 performs non-contact power supply to the cooking device 600 as an electric device such as an induction cooking device in the second power supply mode. The cooking device 600 includes a control unit 610, an operation unit 620, a power receiving unit (non-contact power receiving device) 630, and a heating unit 640. The control unit 610 is configured by using a microcomputer including a processor including a CPU or an FPGA and a memory including a RAM or a ROM. The operation unit 620 is configured by using a touch panel display such as a liquid crystal display and an organic EL display, or a mechanical button or dial. The power receiving unit 630 includes a secondary coil 631 and an electromagnetic induction coil 632. The heating unit 640 is configured by using a heating coil or the like.

The secondary coil 631 is an LC resonance coil, and configured to be capable of receiving power from the non-contact power supply device 400 by resonating with the primary coil 404 of the non-contact power supply device 400 via an electromagnetic field. The electromagnetic induction coil 632 is disposed coaxially with the secondary coil 631 and can be magnetically coupled to the secondary coil 631 through electromagnetic induction. The electromagnetic induction coil 632 obtains, thorough electromagnetic induction, electric power received by the secondary coil 631. The power receiving unit 630 transmits the received electric power to the heating unit 640 via a rectifier, an inverter, and the like. At this time, the control unit 610 controls the inverter and the like based on the information that is related to the output of the heating unit 640 (heating coil) and that is input by the user by operating the operation unit 620, and adjusts the electric power transmitted from the power receiving unit 630 to the heating unit 640. The heating unit 640 heats a cooking utensil such as a pot placed on the cooking device 600 (heating unit 640) by passing the transmitted electric power through the heating coil.

Accordingly, in disaster situations, the non-contact power supply device 400 performs non-contact power supply to the cooking device 600 in the second power supply mode, allowing the user to cook using the cooking device 600. Therefore, it is possible to give higher priority to meals for disaster victims than to charging the vehicle 10.

Moreover, in the example shown in FIG. 5, an input device 700 that the user can operate to input disaster information about the occurrence of a disaster is disposed near the non-contact power supply device 400. The input device 700 includes a control unit 710, an operation unit 720, a storage unit 730, and a wireless communication unit 740. The control unit 710 is configured by using a microcomputer including a processor including a CPU or an FPGA and a memory including a RAM or a ROM. The operation unit 720 is configured by using a touch panel display such as a liquid crystal display and an organic EL display, or a mechanical button or dial. The storage unit 730 is configured by using a storage device such as an erasable programmable ROM (EPROM) and a hard disk drive (HDD). The wireless communication unit 740 is configured to be able to perform wireless communication with the external communication device 408 of the non-contact power supply device 400 by Wi-Fi, Bluetooth (registered trademark), or the like not via the communication network 500.

When the user operates and performs an input to the operation unit 720, the control unit 710 transmits the disaster information about occurrence of a disaster stored in the storage unit 730 from the wireless communication unit 740 to the external communication device 408 of the non-contact power supply device 400. This allows the non-contact power supply device 400 to execute the second power supply mode and to perform non-contact power supply to the cooking device 600 even when it is difficult to use the communication network 500 or the like due to a disaster. The user may input information (type, the resonance frequency of the secondary coil, required electric power, and the like) about the cooking device 600 by operating the operation unit 720 of the input device 700, and the information may be transmitted to the non-contact power supply device 400. This allows the non-contact power supply device 400 to perform optimal non-contact power supply to the cooking device 600 to use.

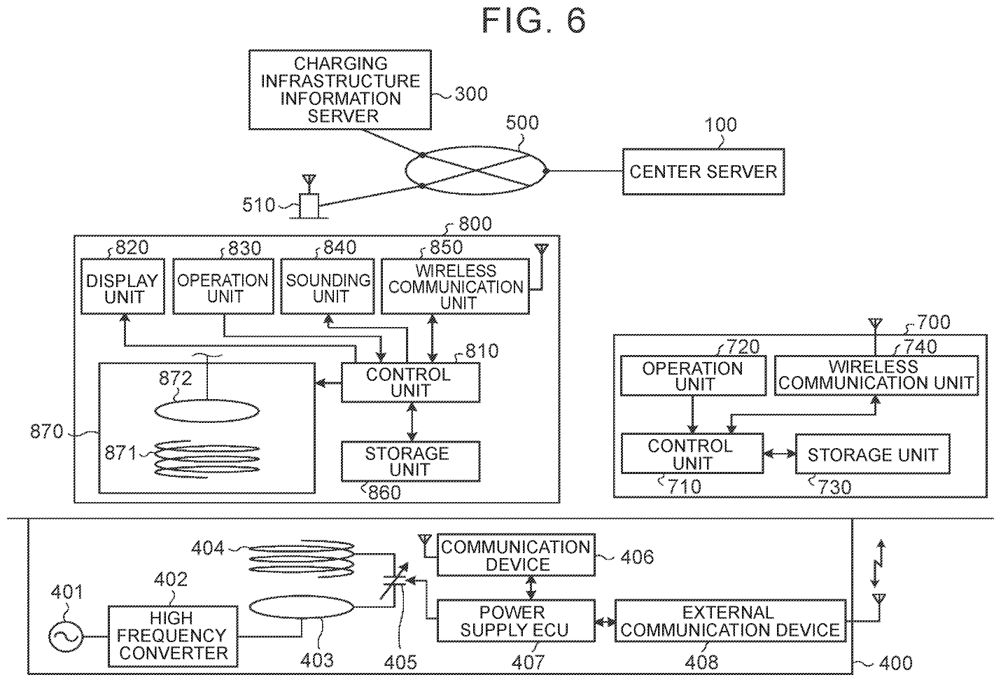

FIG. 6 is a diagram showing an example of the non-contact power supply system when an electric device is a mobile communication terminal device 800.

In the example shown in FIG. 6, the non-contact power supply device 400 performs non-contact power supply to the mobile communication terminal device 800 serving as an electric device such as a smartphone in the second power supply mode. The mobile communication terminal device 800 includes a control unit 810, a display unit 820, an operation unit 830, a sounding unit 840, a wireless communication unit 850, a storage unit 860, and a power receiving unit (non-contact power receiving device) 870. The control unit 810 includes as a main portion: a microcomputer including a processor including a CPU or an FPGA, and a memory including a RAM or a ROM. The display unit 820 and the operation unit 830 are configured by using a touch panel display such as a liquid crystal display and an organic EL display. The sounding unit 840 is configured by using an amplifier, a speaker, and the like to provide voice guidance. The wireless communication unit 850 has a function of communicating with the outside by wireless communication. The storage unit 860 is configured by using a storage device such as an erasable programmable ROM (EPROM) and a hard disk drive (HDD). The power receiving unit 870 includes a secondary coil 871 and an electromagnetic induction coil 872.

The secondary coil 871 is an LC resonance coil, and configured to be capable of receiving power from the non-contact power supply device 400 by resonating with the primary coil 404 of the non-contact power supply device 400 via an electromagnetic field. The electromagnetic induction coil 872 is disposed coaxially with the secondary coil 871 and can be magnetically coupled to the secondary coil 871 through electromagnetic induction. The electromagnetic induction coil 872 obtains, through electromagnetic induction, electric power received by the secondary coil 871. The power receiving unit 870 outputs the received electric power to a battery via a rectifier, a DC/DC converter, and the like.

Accordingly, in disaster situations, the non-contact power supply device 400 performs non-contact power supply to the mobile communication terminal device 800 in the second power supply mode, allowing charging of the battery provided in the mobile communication terminal device 800. Therefore, it is possible to give higher priority to ensuring means of communication for disaster victims than to charging the vehicle 10.

Similarly to the example shown in FIG. 5, in the example shown in FIG. 6, the user may input disaster information about the occurrence of a disaster by operating the operation unit 720 of the input device 700 disposed near the non-contact power supply device 400, and the information may be transmitted to the non-contact power supply device 400. This allows the non-contact power supply device 400 to execute the second power supply mode to perform non-contact power supply to the mobile communication terminal device 800 even when it is difficult to use the communication network 500 or the like due to a disaster. The user may input information (type, the resonance frequency of the secondary coil, required electric power, and the like) about the mobile communication terminal device 800 by operating the operation unit 720 of the input device 700, and the information may be transmitted to the non-contact power supply device 400. This allows the non-contact power supply device 400 to perform optimal non-contact power supply to the mobile communication terminal device 800 to use.

In the example shown in FIG. 6, the user may input disaster information and information about the mobile communication terminal device 800 by operating the operation unit 830 of the mobile communication terminal device 800, and the information may be transmitted to the non-contact power supply device 400. This allows the non-contact power supply device 400 to execute the second power supply mode to perform non-contact power supply to the mobile communication terminal device 800 even when it is difficult to use the communication network 500 or the like due to a disaster. Cost reduction is also possible because it is unnecessary to provide the input device 700 near the non-contact power supply device 400.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. A control device comprising a processor configured to make power supply capacity of a non-contact power supply device smaller when disaster information is acquired than when the disaster information is not acquired.

2. The control device according to claim 1, wherein:
the processor executes a first mode in which first electric energy is output from the non-contact power supply device when the disaster information is not acquired; and
the processor executes a second mode in which second electric energy that is smaller than the first electric energy is output from the non-contact power supply device when the disaster information is acquired.

3. The control device according to claim 2, wherein the processor causes the non-contact power supply device to output the first electric energy to a vehicle and the second electric energy to an electric device other than the vehicle.

4. The control device according to claim 3, wherein the electric device is a cooking device.

5. The control device according to claim 3, wherein the electric device is a mobile communication terminal device.

6. The control device according to claim 1, the control device being provided in the non-contact power supply device.

7. A non-contact power supply program causing a processor to make power supply capacity of a non-contact power supply device smaller when disaster information is acquired than when the disaster information is not acquired.

8. The non-contact power supply program according to claim 7, the non-contact power supply program causing the processor to execute: a first mode in which first electric energy is output from the non-contact power supply device when the disaster information is not acquired; and a second mode in which second electric energy that is smaller than the first electric energy is output from the non-contact power supply device when the disaster information is acquired.

9. The non-contact power supply program according to claim 8, the non-contact power supply program causing the processor to cause the non-contact power supply device to output the first electric energy to a vehicle and to output the second electric energy to an electric device other than the vehicle.

10. The non-contact power supply program according to claim 9, wherein the electric device is a cooking device.

11. The non-contact power supply program according to claim 9, wherein the electric device is a mobile communication terminal device.

12. The non-contact power supply program according to claim 7, wherein the processor is provided in the non-contact power supply device.

13. A non-contact power supply system comprising:
a control device including a first processor configured to make power supply capacity of a non-contact power supply device smaller when disaster information is acquired than when the disaster information is not acquired; and
a server including a second processor configured to output the disaster information to the control device.

14. The non-contact power supply system according to claim 13, wherein:
the first processor executes a first mode in which first electric energy is output from the non-contact power supply device when the disaster information is not acquired; and
the first processor executes a second mode in which second electric energy that is smaller than the first electric energy is output from the non-contact power supply device when the disaster information is acquired.

15. The non-contact power supply system according to claim 14, wherein the first processor causes the non-contact power supply device to output the first electric energy to a vehicle and to output the second electric energy to an electric device other than the vehicle.

16. The non-contact power supply system according to claim 15, wherein the electric device is a cooking device.

17. The non-contact power supply system according to claim 15, wherein the electric device is a mobile communication terminal device.

18. The non-contact power supply system according to claim 13, wherein the control device is provided in the non-contact power supply device.

19. The non-contact power supply system according to claim 13, wherein information about a resonance frequency of a power receiving coil is output from a non-contact power receiving device to the non-contact power supply device.

20. The non-contact power supply system according to claim 13, wherein information about required electric power is output from a non-contact power receiving device to the non-contact power supply device.
